(19) United States
(12) Patent Application Publication
(10) Pub. No.: US 2023/0390689 A1
(43) Pub. Date: Dec. 7, 2023

(54) USE OF THERMALLY CO2- AND/OR H2O-TREATED SOOT PARTICLES FOR SEPARATING POLYHALOGENATED COMPOUNDS

(71) Applicants: Babcock & Wilcox Volund AB, GOTEBORG (DE); Karlsruher Institut für Technologie, Karlsruhe (DE)

(72) Inventors: Hans Hunsinger, Weingarten (DE); Sven Andersson, Hisings Backa (DE)

(21) Appl. No.: 18/204,448

(22) Filed: Jun. 1, 2023

(30) Foreign Application Priority Data
Jun. 1, 2022 (DE) 10 2022 113 834.8

(51) Int. Cl. B01D 53/02; B01J 20/20; B01J 20/30; B01J 20/28

(52) U.S. Cl. CPC B01D 53/025; B01J 20/20; B01J 20/3078; B01J 20/28004; B01J 20/28026

(57) ABSTRACT

The present invention relates to the use of thermally CO₂- and/or H₂O-treated soot particles, integrated in a matrix, for separating polyhalogenated compounds, such as polyhalogenated dibenzo-para-dioxins, polyhalogenated dibenzo-furans, and/or dioxin-like polyhalogenated biphenyls.

### CROSS-REFERENCE TO RELATED APPLICATION(S)

The present application claims priority to German patent application 10 2022 113 834.8 filed on Jun. 1, 2022, which is incorporated herein by reference in its entirety.

### DESCRIPTION

The present invention relates to the use of thermally CO₂- and/or H₂O-treated soot particles, integrated in a matrix, for separating polyhalogenated compounds.

Polyhalogenated compounds are, for example, polychlorinated dioxins and furans, which form for example in combustion processes and are discharged together with the waste gas. 75 polychlorinated dibenzo-para-dioxins (PCDD) and 135 polychlorinated dibenzo-furans (PCDF) (also PCDD/PCDF) exist. These are usually present as mixtures of individual compounds (congeners) having different compositions.

On account of their toxicity, there is a limit for the emission of these compounds. For the incineration and also co-incineration of waste, for example emissions limits of 0.1 ng I-TEQ/Nm³ apply for the waste gas (1-TEQ=International Toxic Equivalents), but this has in the meantime been toughened by the EU Waste Incineration BREF (BAT Reference Document) to 0.01-0.04 ng I-TEQ/Nm³ for new plants. For existing plants, 0.01-0.06 ng I-TEQ/Nm³ is provided.

The concentration of the PCDD/PCDF and mercury in the corresponding incineration waste gas can be reduced to be below the prescribed limit value, for example by means of a downstream tissue filter having active carbon metering.

The use of active carbon for separating organochlorines and mercury from a flue gas is also possible in wet scrubbers (Thomas Löser: Einsatz von Aktivkohlen zur PCDD/F-Minderung [Use of active carbon for PCDD/F reduction], Abfallwirtschaftsjournal [Waste management journal] 4 (1992), No. 11, 893-902). However, this means that the correspondingly laden active carbon particles in the suspension are ultimately contaminated with PCDD/F and mercury, and accordingly have to be disposed of in a complex manner. Furthermore, the use of active carbon in a wet scrubber system is additionally characterized by finely dispersed dust of the active carbon, and accordingly leads to increased contamination in the washing water, which in turn requires the use of additional filters. Furthermore, all surfaces of apparatus parts which come into contact with the washing suspension are contaminated with pollutant-laden carbon particles.

DE 44 25 658 C1 furthermore discloses a method for separating polyhalogenated compounds, in which a waste gas is guided through a packed bed consisting of a polyolefin, for example polypropylene (PP). In this connection, it is shown that PP is particularly suitable as an absorption material for PCDD/PCDF, while mercury is not absorbed or adsorbed by polyolefins. Furthermore, the PP molded parts laden with PCDD/PCDF can be regenerated by temperature increase and the desorption of PCDD/F achieved thereby.

The PCDD/PCDF from the incineration gas is thus not irreversibly fixed in pure PP, but it is merely an absorption/desorption equilibrium which is greatly dependent on the temperature and the PCDD/PCDF concentration.

In particular in waste incineration plants comprising wet scrubber systems, in which PP is typically used as the material, the PCDD/PCDF content in the incineration gas varies depending on the operating state and, in the worst case, a portion of the PCDD/PCDF introduced into the wet scrubber system in small concentrations is absorbed in the PP and builds up significantly over time. Preferably in non-standard operation (startup and shutdown times, incidents) significantly increased PCDD/PCDF concentrations in the incineration gas should be anticipated. This leads in turn to increased PCDD/PCDF contamination of the PP components and means that, after a longer operating time of the wet scrubber systems, the PCDD/PCDF are built up so significantly in the PP that, in normal operation and/or in the case of slight changes of the operating state, for example increases in temperature or reductions in concentration in the waste gas, lead to PCDD/PCDF desorption. Therefore, in such plants, either an additional unit for PCDD/PCDF separation has to be added on at the end of the waste gas purification path (“police filter”), or the release of the PCDD/PCDF out of the PP construction materials of the wet scrubber system must be prevented.

In order to counter the problem of the desorption of PCDD/PCDF from PP, finely dispersed solid particles have already been incorporated into the corresponding polyolefin matrix, which particles can irreversibly adsorb PCDD/PCDF (cf. DE 101 64 066 B4). Since mercury is not absorbed by polyolefins, this polyolefin matrix, doped with adsorbent particles, can be incinerated after use, which leads to a quantitative destruction of the PCDD/PCDF without large amounts of mercury being released. In particular carbon particles, preferably finely ground active carbon, such as hearth furnace coke, and/or soot particles, are suitable as solid particles. These adsorbents ensure, with increasing mass fraction and when homogeneously distributed in the polyolefin matrix, (a) a better separation of PCDD/PCDF, (b) but unfortunately also a reduction in the strength characteristics, which is particularly pronounced in the case of addition of soot particles, (e.g. tensile strength) of the correspondingly doped polyolefin molded body. In contrast to soot particles, the addition of finely dispersed active carbon particles reduces the strength only slightly. However, a disadvantage of active carbon particles is the more coarsely dispersed particle size distribution compared with soot particles, as a result of which homogeneous mixing in the PP is made more difficult. Coarse particles tend significantly more to demixing by sedimentation in the melt of the matrix.

Correspondingly, the object of the present invention is that of providing a use of finely dispersed carbon particles (soot particles), which are integrated homogeneously in a thermoplastic matrix in a high concentration, for separating polyhalogenated compounds, wherein the separation of the polyhalogenated compounds is maximized and at the same time the strength characteristics of the original thermoplastic matrix are maintained or worsened only marginally.

The object described above is achieved by the embodiments of the present invention set out in the claims.

In particular, according to the invention a use of thermally CO₂- and/or H₂O-treated soot particles, integrated in a matrix, for separating polyhalogenated compounds is provided, wherein the matrix contains at least one thermoplastic, and wherein, based on 100 mass % matrix, 0.01 mass % or more and 30.00 mass % or less of the thermally CO₂- and/or H₂O-treated soot particles are integrated in the matrix.

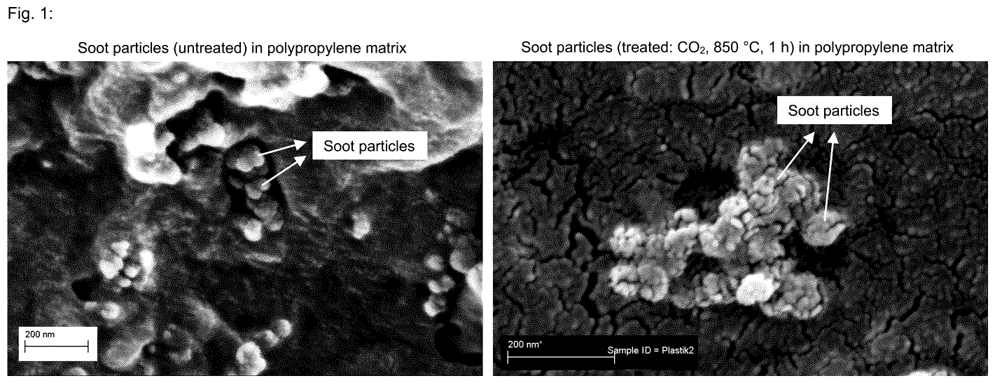

Due to the thermal CO₂ and/or H₂O treatment of the soot particles, the surface of said particles exhibits improved wetting with thermoplastic melts in the event of corresponding thermal extrusion, such that close contact and, upon subsequent cooling, a form-fitting connection between the thermally CO₂- and/or H₂O-treated soot particles and the thermoplastic matrix results. In this respect FIG. 1 shows, by way of example, thermally CO₂- and/or H₂O-treated soot particles, used according to the invention and integrated in a polypropylene matrix (left), and thermally CO₂- and/or H₂O-untreated soot particles integrated in a polypropylene matrix (right), in order to illustrate the advantageous close contact, according to the invention, of the thermally CO₂- and/or H₂O-treated soot particles with the thermoplastic matrix. Consequently, this use according to the invention advantageously results in the phase transition of the polyhalogenated compounds from the thermoplastic matrix to the soot particles being improved, and the strength characteristics of the original thermoplastic matrix being retained or only marginally impaired.

According to the invention, thermally CO₂- and/or H₂O-treated soot particles integrated in a matrix are used for separating polyhalogenated compounds.

Soot is a black, powdery solid which, depending on the quality and use, consists of 80.0 to 99.5% carbon, which is produced by incomplete combustion (combustion soot) or by thermal decomposition or pyrolysis (fission soot), and is used mainly as a filler in the rubber industry.

The thermally CO₂- and/or H₂O-treated soot particles are not further restricted according to the invention, provided that they have been thermally treated with CO₂ and/or H₂O.

In a preferred embodiment, the soot is treated with CO₂ and/or H₂O at 500° C. or more and 1000° C. or less, preferably 550° C. or more and 950° C. or less, more preferably 600° C. or more and 900° C. or less, and particularly preferably 650° C. or more and 850° C. or less. The soot can be treated with CO₂ and/or H₂O for example at 500 to 950° C., 500 to 900° C., 500 to 850° C., 550 to 1000° C., 550 to 900° C., 550 to 850° C., 600 to 1000° C., 600 to 950° C., 600 to 850° C., 650 to 1000° C., 650 to 950° C. or 650 to 900° C. At low temperatures, a long treatment time is necessary in this connection. At high temperatures, in contrast, the kinetics of the reaction are very quick, which, however, requires complex reaction control.

The time of the thermal CO₂- and/or H₂O treatment of the soot is not further restricted according to the invention, provided that the soot is thermally treated with CO₂ and/or H₂O. Preferably, the soot is thermally treated with CO₂ and/or H₂O for 0.1 hours or more, more preferably 0.3 hours or more, more preferably 0.5 hours or more, and particularly preferably 0.7 hours or more. As an upper limit value, the soot is preferably thermally treated with CO₂ and/or H₂O for 10.0 hours or less, more preferably 7.0 hours or less, more preferably 4.0 hours or less, and particularly preferably 2.0 hours or less. The soot can be treated with CO₂ and/or H₂O for example for 0.1 to 10.0 hours, 0.1 to 7.0 hours, 0.1 to 4.0 hours, 0.1 to 2.0 hours, 0.3 to 10.0 hours, 0.3 to 7.0 hours, 0.3 to 4.0 hours, 0.3 to 2.0 hours, 0.5 to 10.0 hours, 0.5 to 7.0 hours, 0.5 to 4.0 hours, 0.5 to 2.0 hours, 0.7 to 10.0 hours, 0.7 to 7.0 hours, 0.7 to 4.0 hours or 0.7 to 2.0 hours. Particularly preferably, the soot is thermally treated with CO₂ and/or H₂O for 0.7 hours or more and 2.0 hours or less.

The pressure of the thermal CO₂- and/or H₂O treatment of the soot is not further restricted according to the invention. Preferably, the soot is thermally treated with CO₂ and/or H₂O at 0.1 bar or more, more preferably 0.4 bar or more, more preferably 0.7 bar or more, and particularly preferably 1.0 bar or more. As an upper limit value, the soot is preferably thermally treated with CO₂ and/or H₂O at 10.0 bar or less, more preferably 7.0 bar or less, more preferably 4.0 bar or less, and particularly preferably 2.0 bar or less. The soot can be treated with CO₂ and/or H₂O for example at 0.1 to 10.0 bar, 0.1 to 7.0 bar, 0.1 to 4.0 bar, 0.1 to 2.0 bar, 0.4 to 10.0 bar, 0.4 to 7.0 bar, 0.4 to 4.0 bar, 0.4 to 2.0 bar, 0.7 to 10.0 bar, 0.7 to 7.0 bar, 0.7 to 4.0 bar, 0.7 to 2.0 bar, 1.0 to 10.0 bar, 1.0 to 7.0 bar, 1.0 to 4.0 bar, or 1.0 to 2.0 bar.

The thermal treatment of the soot with CO₂ and/or H₂O is not further restricted according to the invention, provided that the soot is thermally treated with CO₂ and/or H₂O. During the thermal treatment of the soot with CO₂ and/or H₂O, the shell of the soot particles oxidizes in part and, depending on the substance used (CO₂ and/or H₂O), the following reactions take place: (a) CO₂+C to 2CO and/or (b) H₂O+C to CO+H₂. In this case, H₂O is preferably used as water vapor.

The gas used for the thermal treatment of the soot with CO₂ and/or H₂O can, in addition to H₂O in the form of water vapor, and/or CO₂, furthermore contain the reaction products CO and/or H₂, as well as at least one inert gas, selected from the group consisting of nitrogen, helium, neon, argon, krypton, xenon and radon.

The thermal treatment of the soot with CO₂ and/or H₂O can be carried out in a plurality of reactions, provided that these are suitable for the thermal treatment of soot with CO₂ and/or H₂O, for example shaft furnaces, deck ovens, rotary kilns or entrained flow reactors comprising separators.

The resulting thermally CO₂- and/or H₂O-treated soot particles preferably comprise a solid core and an (outer) shell. In this case, the solid core consists substantially of thermally CO₂- and/or H₂O-untreated soot, and the shell consists substantially of thermally CO₂- and/or H₂O-treated soot, i.e. the outer shell is (only) structured, whereas an untreated soot surface is smooth. In this case, “substantially” means at least 80 vol.-%, preferably at least 90 vol.-%, and more preferably at least 95 vol.-%. Particularly preferably exclusively thermally CO₂- and/or H₂O-untreated soot is present in the solid core, and exclusively thermally CO₂- and/or H₂O-treated soot is present in the shell.

In a preferred embodiment, the thermally CO₂- and/or H₂O-treated soot particles have a maximum particle diameter of 200 nm or less, preferably 150 nm or less, more preferably 100 nm or less, and particularly preferably 50 nm or less.

The maximum particle diameter, defined above, of the thermally CO₂- and/or H₂O-treated soot particles used according to the invention can be determined for example by means of scanning electron microscopy (SEM).

The shape and/or geometry of said thermally CO₂- and/or H₂O-treated soot particles is not further restricted according to the invention. Thus, these can be for example spherical particles or ellipsoidal particles. The thermally CO₂- and/or H₂O-treated soot particles can also congregate, in part or exclusively, to agglomerations, and be present as such, embedded in the thermoplastic matrix.

The thermally CO₂- and/or H₂O-treated soot particles used according to the invention preferably have a mass-related specific surface area of 250 m²/g or more, more preferably 270 m²/g or more, more preferably 290 m²/g or more, and particularly preferably 310 m²/g or more. The upper limit of the mass-related specific surface area of the thermally CO₂- and/or H₂O-treated soot particles is not further restricted according to the invention.

The mass-related specific surface area of the thermally CO₂- and/or H₂O-treated soot particles used according to the invention can be determined for example by a Brunauer-Emmett-Teller (BET) measurement, using a Quantachrome NovaWin (with N₂).

The matrix is not further restricted according to the invention, provided that it comprises at least one thermoplastic. The thermoplastic is preferably at least one selected from the group consisting of polyolefin, poly(meth)acrylate, polyether, polyester, polyethylene glycol, polyketone, polyurethane, polyamide, polyamine, polyurea, polysiloxane, polytetrafluoroethylene, polyphenylene ether, polyphenylene oxide, polyphenylene sulfide, polystyrene, polyvinylidene difluoride, polyvinylchloride, mixtures thereof, derivatives thereof, and copolymers thereof. The thermoplastic is more preferably a polyolefin, and particularly preferably at least one selected from the group consisting of polyethylene (PE), polypropylene (PP), polybutylene (PB), polyisobutylene (PIB) and polymethylpentene (PMP).

Furthermore, the matrix can contain further components such as dyes, residual solvents and/or plasticizers. In addition to the thermally CO₂- and/or H₂O-treated soot particles used according to the invention, further fillers can also be embedded in the matrix, provided that these do not or only marginally worsen the strength values of the matrix in the process. For example, in addition to the thermally CO₂- and/or H₂O-treated soot particles used according to the invention, active carbon particles, hearth furnace coke particles and/or thermally CO₂- and/or H₂O-untreated soot particles can also sometimes be integrated in the matrix.

According to the invention, based on 100 mass % matrix, 0.01 mass % or more and 30.00 mass % or less of the thermally CO₂- and/or H₂O-treated soot particles are integrated in the matrix. Based on 100 mass % matrix, preferably 1.00 mass % or more and 27.00 mass % or less of the thermally CO₂- and/or H₂O-treated soot particles are integrated in the matrix, more preferably 5.00 mass % or more and 24.00 mass % or less, more preferably 10.00 mass % or more and 22.00 mass % or less, and particularly preferably 15.00 mass % or more and 20.00 mass % or less.

For example, based on 100 mass % matrix, 0.01 to 27.00 mass %, 0.01 to 24.00 mass %, 0.01 to 22.00 mass %, 0.01 to 20.00 mass %, 1.00 to 30.00 mass %, 1.00 to 24.00 mass %, 1.00 to 22.00 mass %, 1.00 to 20.00 mass %, 5.00 to 30.00 mass %, 5.00 to 27.00 mass %, 5.00 to 22.00 mass %, 5.00 to 20.00 mass %, 10.00 to 30.00 mass %, 10.00 to 27.00 mass %, 10.00 to 24.00 mass %, 10.00 to 20.00 mass %, 15.00 to 30.00 mass %, 15.00 to 27.00 mass %, 15.00 to 24.00 mass % or 15.00 to 22.00 mass % of the thermally CO₂- and/or H₂O-treated soot particles may be integrated in the matrix. If, based on 100 mass % matrix, more than 30.00 mass % thermally CO₂- and/or H₂O-treated soot particles are integrated in the matrix, the strength values of the matrix are increasingly worsened.

If, in addition to the thermally CO₂- and/or H₂O-treated soot particles used according to the invention, further fillers are also present embedded in the matrix, then the total mass of the thermally CO₂- and/or H₂O-treated soot particles and the further fillers, which are integrated in the matrix, is 30.00 mass % or less with respect to 100 mass % matrix.

According to the invention, the thermally CO₂- and/or H₂O-treated soot particles are integrated in the matrix defined above. In this connection, “integrated” means that the thermally CO₂- and/or H₂O-treated soot particles and the matrix are mixed with one another.

In a preferred embodiment of the use according to the invention, the thermally CO₂- and/or H₂O-treated soot particles are homogeneously distributed and/or completely embedded in the matrix. In this connection, “completely embedded” means that each of the thermally CO₂- and/or H₂O-treated soot particles is completely encased by the matrix, such that ideally no thermally CO₂- and/or H₂O-treated soot particles are present on any surfaces.

Since the polyhalogenated compounds sought for separation diffuse well in thermoplastics and are incorporated, i.e. absorbed, uniformly in volumes, the thermally CO₂- and/or H₂O-treated soot particles used according to the invention are also available for irreversible separation of polyhalogenated compounds.

The polyhalogenated compounds sought for separation are preferably polyhalogenated dibenzo-para-dioxins, polyhalogenated dibenzo-furans and/or dioxin-like polyhalogenated biphenyls. Particularly preferably, the polyhalogenated compounds sought for separation are at least one selected from the group consisting of polychlorinated dibenzo-para-dioxins (PCDD), polychlorinated dibenzo-furans (PCDF), dioxin-like polychlorinated biphenyls (dlPCB), polybrominated dibenzo-para-dioxins (PBDD), polybrominated dibenzo-furans (PBDF), dioxin-like polybrominated biphenyls (dlPBB), mixed chlorinated and brominated dibenzo-para-dioxins (PXDD), mixed chlorinated and brominated dibenzo-furans (PXDF), and dioxin-like mixed chlorinated and brominated biphenyls (dlPXB). According to the invention, “separating” means irreversible absorption and/or adsorption of the polyhalogenated compounds on a surface of the thermally CO₂- and/or H₂O-treated soot particles used according to the invention, which particles are integrated in the matrix.

In a preferred embodiment, the above-defined matrix according to the invention comprising the integrated thermally CO₂- and/or H₂O-treated soot particles is used in a waste gas purification system. The waste gas purification system is preferably (i) a wet scrubber system or (ii) a system in which a gas can flow through the gas to be purified, with or without water condensation, and with or without addition of a liquid, in dry or wet form.

A plurality of components of a waste gas purification system can be produced from the matrix comprising the integrated thermally CO₂- and/or H₂O-treated soot particles. The usual fillers of ballast in a packed bed constitute a conventional field of use for the matrix according to the invention comprising the integrated thermally CO₂- and/or H₂O-treated soot particles. In a preferred embodiment of the present invention, the matrix comprising the integrated thermally CO₂- and/or H₂O-treated soot particles is accordingly in the form of a filler, a demister molded body and/or knitted fiber packing.

In this connection, the shape of a filler can be at least one selected from the group consisting of Berl saddle shape, Intalox saddle shape, Novalox saddle shape, BIO-NET shape, Hackett shape, Hel-X shape, Hiflow ring shape, NOR-PAC shape, Pall ring shape, Raschig ring shape, saddle shape, Top Pak shape, VFF-NetBall shape, VFF-Igel shape, Telpac shape, Telerette shape, snowflake shape, cascade mini-ring shape, Q-pack shape, BIOdek shape, MASSdek shape, Mellapak shape, VSP shape, and structured packing.

However, the matrix comprising the integrated thermally CO₂- and/or H₂O-treated soot particles can also be in the form of other bodies, such as fabric mats, fibers, chippings, strips, granulates and/or molded parts produced by injection molding.

However, other components such as droplet separators, pipe linings, enclosures through which a flow can travel, containers for the fillers, false floors, or other structural components of a waste gas purification system, which are in direct contact with the waste gas or the washing water, are a field of application for the above-defined matrix according to the invention comprising the integrated thermally CO₂- and/or H₂O-treated soot particles. In this case, it is advantageously expedient to replace the components of the waste gas purification system which are already produced from thermoplastics, without fundamental structural changes, by those of the matrix according to the invention defined above, comprising the integrated thermally CO₂- and/or H₂O-treated soot particles.

The above-defined fillers, demister molded bodies, knitted fiber packings, and other bodies and components of the waste gas purification system can be produced for example by means of an injection molding method, which comprises the following steps:
(a) integrating thermally CO₂- and/or H₂O-treated soot particles in a matrix, which contains at least one thermoplastic, by mixing the thermally CO₂- and/or H₂O-treated soot particles with the matrix using a heated single- or twin-screw extruder, wherein, based on 100 mass % matrix, 0.01 mass % or more and 30.00 mass % or less of the thermally CO₂- and/or H₂O-treated soot particles are integrated in the matrix;
(b) injecting the mixture consisting of the matrix with the integrated thermally CO₂- and/or H₂O-treated soot particles into a corresponding cavity of an injection mold; and
(c) cooling the mixture consisting of the matrix with the integrated thermally CO₂- and/or H₂O-treated soot particles in the cavity of the injection mold.

According to the invention, the strength characteristics, such as tensile strength, of the above-defined matrix are not, or are only marginally, impaired by integration of thermally CO₂- and/or H₂O-treated soot particles.

If the tensile strength of the above-defined matrix without integrated thermally CO₂- and/or H₂O-treated soot particles is set as 100%, then “only marginally” means that the tensile strength of the above-defined matrix changes by only 20% or less preferably 17% or less, more preferably 14% or less, more preferably 11% or less, and particularly preferably 8% or less by integration of the thermally CO₂- and/or H₂O-treated soot particles.

The tensile strength is defined according to the invention as the maximum tensile stress that the corresponding molded body withstands before it breaks.

In the figures:

FIG. 1 shows thermally CO₂- and/or H₂O-untreated soot particles integrated in a polypropylene matrix (left), and thermally CO₂- and/or H₂O-treated soot particles, used according to the invention, integrated in a polypropylene matrix (right).

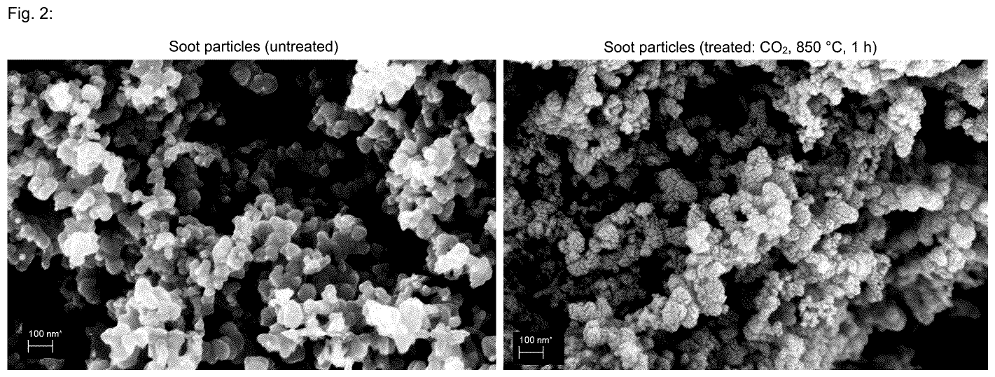

FIG. 2 shows scanning electron microscope images of thermally CO₂- and/or H₂O-untreated soot particles (left), and thermally CO₂- and/or H₂O-treated soot particles used according to the invention (right).

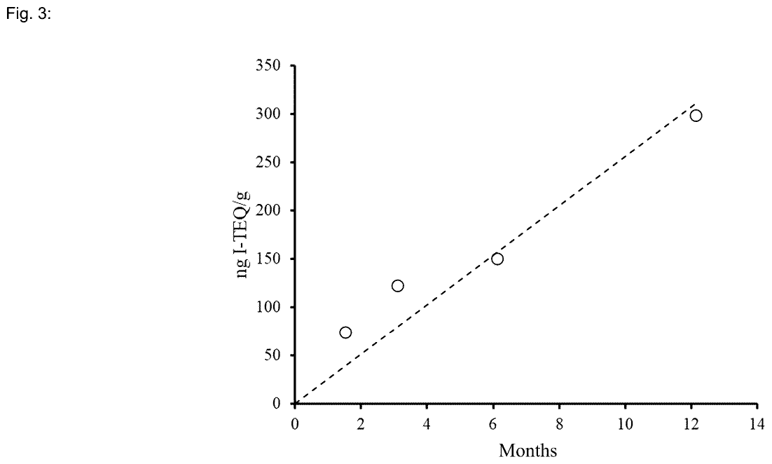

FIG. 3 shows the separation amount (ng I-TEQ/g) of PCDD/PCDF in a polypropylene matrix comprising integrated thermally CO₂-treated soot particles over a period of up to 12 months.

### EXAMPLES

The invention is illustrated further in the following.

Soot particles were thermochemically treated at 850° C. with CO₂ for a time period of 1 hour, wherein thermally CO₂-treated soot particles provided according to the invention were produced. In this respect, FIG. 2 shows scanning electron microscope (SEM) images of the untreated soot particles (left) and of the thermally CO₂-treated soot particles provided according to the invention (left).

Said thermally CO₂-treated primary soot particles had a mass-related specific surface area of 324 m²/g and a maximum particle diameter of <100 nm, approx. 50-20 nm, which, as described above, were determined by means of SEM.

Subsequently, the soot particles thermally CO₂-treated in this way were mixed with polypropylene in a twin-screw extruder, and thereafter injected into a corresponding injection molding tool. After cooling, a corresponding molded body was obtained.

The tensile strength of a standard test specimen Type 1A according to ISO 527 from this material was determined according to ISO 527 and amounted to 23.2 MPa.

As a comparative sample, an equivalent standard test specimen made of polypropylene without integrated soot particles had a tensile strength of 25 MPa.

Consequently, the tensile strength of the polypropylene was reduced by just 7% by the integration of thermally CO₂-treated soot particles (here 16 mass % with respect to 100 mass % polypropylene).

The corresponding comparative example was produced analogously to the example according to the invention, with the exception that, instead of thermally CO₂-treated soot particles used according to the invention, thermally CO₂-untreated soot particles were integrated in the matrix.

In this case, the soot particles had a mass-related specific surface area of 240 m²/g and a maximum particle diameter of approx. 50-20 nm.

The tensile strength of the obtained molded body of the comparative example was just 16 MPa. Consequently, the tensile strength of the polypropylene was reduced excessively, by 36%, by the integration of 16 mass % thermally CO₂-untreated soot particles with respect to 100 mass % polypropylene.

FIG. 3 shows the separation amount (ng I-TEQ/g) of PCDD/PCDF in a polypropylene matrix comprising integrated thermally CO₂-treated soot particles (examples according to the invention) over a period of up to 12 months.

1. Use of thermally CO₂- and/or H₂O-treated soot particles, integrated in a matrix, for separating polyhalogenated compounds,
wherein the matrix contains at least one thermoplastic, and
wherein, based on 100 mass % matrix, 0.01 mass % or more and 30.00 mass % or less of the thermally CO₂- and/or H₂O-treated soot particles are integrated in the matrix.

2. Use according to claim 1, wherein the thermally CO₂- and/or H₂O-treated soot particles have been treated at 500° C. or more and 1500° C. or less.

3. Use according to claim 1, wherein the thermally CO₂- and/or H₂O-treated soot particles have a mass-related specific surface area of 250 m²/g or more.

4. Use according to claim 1, wherein the thermally CO₂- and/or H₂O-treated soot particles have a maximum particle diameter of 200 nm or less.

5. Use according to claim 1, wherein the thermoplastic is at least one selected from the group consisting of polyolefin, poly(meth)acrylate, polyether, polyester, polyethylene glycol, polyketone, polyurethane, polyamide, polyamine, polyurea, polysiloxane, polytetrafluoroethylene, polyphenylene ether, polyphenylene oxide, polyphenylene sulfide, polystyrene, polyvinylidene difluoride, polyvinylchloride, mixtures thereof, derivatives thereof, and copolymers thereof.

6. Use according to claim 1, wherein the thermally CO₂- and/or H₂O-treated soot particles are homogeneously distributed and/or completely embedded in the matrix.

7. Use according to claim 1, wherein the polyhalogenated compounds are polyhalogenated dibenzo-para-dioxins, polyhalogenated dibenzo-furans and/or dioxin-like polyhalogenated biphenyls.

8. Use according to claim 1, wherein the matrix comprising the integrated thermally CO₂- and/or H₂O-treated soot particles has the form of a filler, a demister molded body and/or a knitted fiber packing.

9. Use according to claim 1 in a waste gas purification system.

10. Use according to claim 9, wherein the waste gas purification system is (i) a wet scrubber system or (ii) a system in which a gas can flow through the gas to be purified, with or without condensation, and with or without addition of a liquid, in dry or wet form.
